(19) United States
(12) Patent Application Publication
(10) Pub. No.: US 2026/0145508 A1
(43) Pub. Date: May 28, 2026

(54) WHEEL ASSEMBLY STRUCTURE OF VEHICLE

(71) Applicants: Hyundai Motor Company, Seoul (KR); Kia Corporation, Seoul (KR)

(72) Inventor: Jonghoon Lee, Hwaseong-si (KR)

(21) Appl. No.: 19/296,459

(22) Filed: Aug. 11, 2025

(30) Foreign Application Priority Data
Nov. 25, 2024 (KR) 10-2024-0169704

(51) Int. Cl. B60K 7/00; B60G 15/04

(52) U.S. Cl. CPC B60K 7/0007; B60G 15/04; B60G 2202/242

(57) ABSTRACT

A wheel assembly structure of a vehicle may include a wheel on which a tire of the vehicle is mounted, a rotor housing connected to the wheel and configured to rotate with the wheel, a stator housing configured to be fixed to a vehicle body, and configured to rotate the rotor housing based on an application of an electrical current at the stator housing, and a damping device coupled between an inner circumference of the wheel and an outer circumference of the rotor housing and configured to alleviate a shock transferred from the wheel to the rotor housing.

### CROSS-REFERENCE TO RELATED APPLICATIONS

This application claims priority to and the benefit of Korean Patent Application No. 10-2024-0169704 filed with the Korean Intellectual Property Office on Nov. 25, 2024, the entire contents of which is incorporated herein by reference.

### TECHNICAL FIELD

The present disclosure relates to a wheel assembly structure of a vehicle.

### BACKGROUND

An in-wheel drive system is mounted on wheels of each vehicle wheel, and in vehicles that run on electric power such as hybrid vehicles, fuel cell vehicles, and electric vehicles, is a system that generates and drives power for each vehicle wheel by installing a small individual motor on each vehicle wheel instead of using a large single motor.

The in-wheel drive system has the advantage of providing individual motors (hereinafter referred to as an in-wheel motor) for each wheel to simplify a drive system and increase an interior space compared to a vehicle equipped with a large drive motor, and being able to directly control the rotation of the vehicle wheels to omit a complex power transmission device such as a differential device.

In this way, power train elements may be omitted, exhibiting high efficiency and high performance. That is, by directly installing the in-wheel motor on the wheels of each vehicle wheel, it is possible to reduce power waste and secure sufficient driving power, and by maximizing the distribution of power to each in-wheel motor during driving and the recovery of braking energy due to regenerative braking when braking, it is possible to improve fuel efficiency.

However, in the in-wheel drive system, the in-wheel motor is integrated with the wheels of the vehicle wheel, so an unsprung mass of the vehicle increases, vibration and noise (NVH) of the vehicle increase, and there is a risk of damage to the in-wheel motor due to shock on a lower portion of the vehicle. In addition, there is a problem of configuring a wheel assembly structure to ensure durability of the in-wheel motor and durability due to movement of a high-voltage cable when the wheels move.

Such an in-wheel drive system is equipped with a shock absorber between the wheel and the stator housing to alleviate the shock between the stator housing and the wheel. A trailing arm, which holds the shock absorber, is connected to the wheel hub of the vehicle. However, the front, rear, left and right loads coming through the vehicle's tires, wheels, wheel hubs, and trailing arms are excessively concentrated on the shock absorbers. Accordingly, if the shock absorber is not maintained with sufficient strength to withstand the load, problems such as damage to the load section may occur, so it is necessary to disperse the concentrated load.

### SUMMARY

The present disclosure relates to a wheel assembly structure of a vehicle, and more particularly, the present disclosure relates to a wheel assembly structure of the vehicle provided with an in-wheel motor.

In an embodiment of the present disclosure, a wheel assembly structure of a vehicle can be capable of improving the strength and durability against the lateral force by install a damping device of an air spring type between the wheel and the rotor housing of the vehicle, so that the shock transferred from the vehicle lower body to the in-wheel motor may be alleviated, and the load concentrated to the shock absorber may be alleviated.

In an embodiment of the present disclosure, a wheel assembly structure of a vehicle may include a wheel on which a tire of the vehicle is mounted, a rotor housing connected to the wheel and rotating with the wheel, a stator housing fixed to the vehicle, and configured to rotate the rotor housing by applying a current, and a damping device provided between an inner circumference of the wheel and an outer circumference of the rotor housing and configured to alleviate a shock transferred from the wheel to the rotor housing.

A wheel hub extending toward the vehicle inner side may be further provided in a central portion of the wheel.

The wheel assembly structure may further include a body engage bracket connected to the stator housing, and extending toward the vehicle inner side to be connected to a body of the vehicle.

The wheel hub may be connected to a trailing arm elongated toward an inner side of the vehicle to support the wheel.

A shock absorber configured to alleviate a shock transferred from the wheel to the body of the vehicle may be installed between an upper portion of the trailing arm and a body of the vehicle.

Around a circumference of the shock absorber, a spring may be disposed between an upper surface of the trailing arm and the body of the vehicle, and may be configured to support a load of the vehicle and alleviate the shock.

Between the outer circumference of the rotor housing and the inner circumference of the wheel, the shock transferred from the wheel to the rotor housing may be transferred to the body through the shock absorber, and a part of a shock transferred to the body may be transferred to the damping device.

A part of a shock transferred to the damping device may be transferred to the motor composed of the rotor housing and the stator housing.

A permanent magnet may be provided on an interior surface of the rotor housing facing a rotation axis of the rotor housing, and a coil may be provided on an exterior surface of the stator housing at a location facing the permanent magnet, so that the rotor housing is operated to rotate by electromagnetic force generated by applying electric power to the coil.

The wheel hub and a trailing arm may be rotatably connected by a wheel hub bearing.

A motor bearing may be provided between an end portion of a central shaft of the stator housing and the rotor housing, so that the rotor housing relatively rotates with respect to the stator housing.

The damping device may be formed of an air spring.

The damping device may be formed by connecting a plurality of cross-sections having a hexagonal-shaped hollow.

According to an embodiment of the present disclosure, by installing a damping device of an air spring type between the wheel and the rotor housing of the vehicle, a portion of the load transferred from the wheel hub may be transferred to the motor, thereby alleviating the load concentrated on the shock absorber.

According to an embodiment of the present disclosure, a damping device of an air spring type absorbing the load transferred to the motor, and a shock absorber absorbing the load transferred through the bearing of the wheel hub may be separately installed in the body, thereby improving the spatial degree of freedom in the aspect of design.

According to an embodiment of the present disclosure, by providing the wheel assembly structure including a motor damping member between the in-wheel motor including the stator and the rotor, it can be possible to alleviate the shock from the lower portion of the vehicle being transmitted to the in-wheel motor and strengthen the durability of the high-voltage cable connected to the in-wheel motor.

According to an embodiment of the present disclosure, by applying to a skateboard platform applied to mobility vehicles, it can be possible to greatly contribute to the marketability of the mobility vehicle.

### BRIEF DESCRIPTION OF THE DRAWINGS

FIG. 1 is a perspective view showing a wheel assembly structure of a vehicle according to an embodiment of the present disclosure as viewed from the inner side of the vehicle.

FIG. 2 is a side view showing a wheel assembly structure of a vehicle according to an embodiment of the present disclosure as viewed from the inner side of the vehicle.

FIG. 3 is a side view showing a wheel assembly structure of a vehicle according to an embodiment of the present disclosure as viewed from the outer side of the vehicle.

FIG. 4 is a cross-sectional view taken along line ‘A-A’of FIG. 2.

FIG. 5 is a cross-sectional view taken along line ‘B-B’of FIG. 2.

FIG. 6 is a drawing schematically showing a path along which a shock of a vehicle lower body can be transferred, in a wheel assembly structure of a vehicle according to an embodiment of the present disclosure.

### DETAILED DESCRIPTION OF ILLUSTRATIVE EMBODIMENTS

Example embodiments of the present disclosure will be described more fully hereinafter with reference to the accompanying drawings. As those skilled in the art can realize, the described example embodiments may be modified in various different ways, all without necessarily departing from the spirit or scopes of the present disclosure.

In various example embodiments, same reference numerals can be used for elements having same configurations and can be representatively described in a first example embodiment, and in other example embodiments, only elements different from those of the first example embodiment may be described.

The drawings are schematic, and are not necessarily illustrated in accordance with a scale. Relative dimensions and ratios of portions in the drawings can be illustrated to be exaggerated or reduced in size for clarity and convenience, and the dimensions are just examples and are not necessarily limiting. Like structures, elements, or components illustrated in two or more drawings can use same reference numerals for showing similar features. It can be understood that when an element is referred to as being “on” another element, it can be directly on the other element or intervening elements may also be present.

Example embodiments of the present disclosure are described in detail, and various modifications of the drawings can be possible. Therefore, an embodiment of the present disclosure is not necessarily limited to a specific shape of an illustrated region, but, for example, can include a change in the shape in accordance with manufacturing.

A wheel assembly structure of a vehicle according to an example embodiment of the present disclosure will be described in detail with reference to the accompanying drawings.

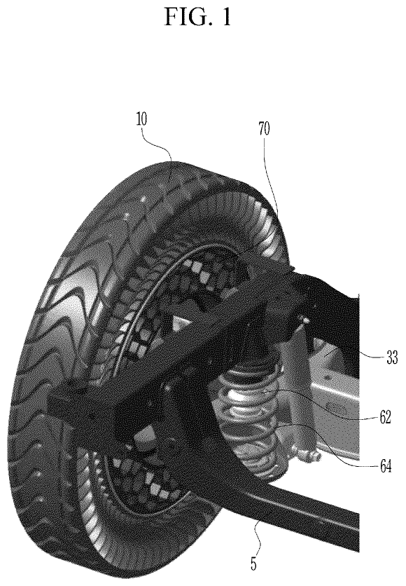

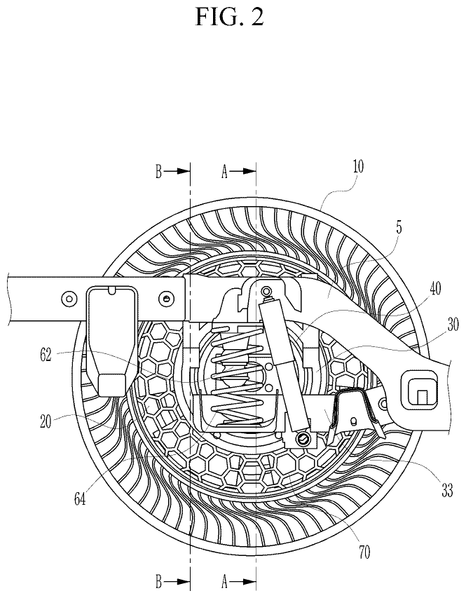

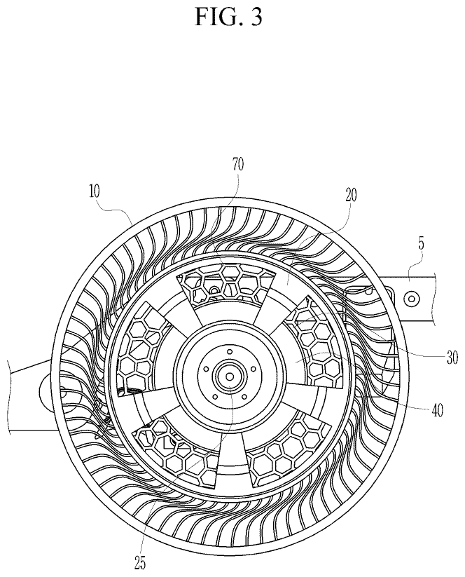

FIG. 1 is a perspective view showing a wheel assembly structure of a vehicle according to an embodiment of the present disclosure as viewed from an inner side of the vehicle. FIG. 2 is a side view showing a wheel assembly structure of a vehicle according to an embodiment of the present disclosure as viewed from the inner side of the vehicle. FIG. 3 is a side view showing a wheel assembly structure of a vehicle according to an embodiment of the present disclosure as viewed from the outer side of the vehicle.

Referring to FIG. 1 to FIG. 4, a wheel assembly structure of a vehicle according to an embodiment of the present disclosure may include: a wheel 20 on which a tire 10 of the vehicle can be mounted; a rotor housing 40 connected to the wheel 20; a stator housing 30 fixed to the vehicle and configured to rotate the rotor housing 40 by applying a current; and a damping device 70 provided between an inner circumference of the wheel 20 and an outer circumference of the rotor housing 40 and configured to alleviate a shock transferred from the tire 10 and the wheel 20 to the rotor housing 40.

The stator housing 30 and the rotor housing 40 may be provided inside a rotor 40 to form an in-wheel motor 45. The in-wheel motor 45 may be an electric vehicle drive system that drives wheels by directly mounting an electric motor on each wheel. Unlike a drive method using a traditional internal combustion engine and a transmission, efficient energy transfer can be possible because the wheels and motors are directly connected.

The wheel 20 can be mainly made of metal and can rotate about a central axis. The wheel 20 can serve to support the tire 10, reduce shock received from the road, and support a weight of the vehicle.

The tire 10 can surround an exterior of the wheel 20 and can be mainly made of rubber and steel wire. The tire 10 may control a direction and speed of the vehicle by using friction with a road surface. The tire 10 can absorb shock from the road surface to provide a comfortable driving environment and increases vehicle safety.

The rotor 40 may be connected to an interior of the wheel 20 for rotating with the wheel 20. The rotor 40 may be a portion configured to rotate upon receiving electricity in the in-wheel motor 45. The rotor 40 may serve to transfer the torque to the wheel. A rotation of the rotor 40 can be a main way of converting electrical power into mechanical energy.

A stator 30 may be fixed to the vehicle, and can rotate the rotor 40 by applying a current. The stator 30 can be a fixed part of the in-wheel motor 45 and may be mainly made of coils 35 and/or magnets 42. When the electrical energy passes through the stator 30, a magnetic field may be generated, and this magnetic field can rotate the rotor 40.

A bearing may be provided between the rotor 40 and the stator 30. The bearing can allow a shaft to move between the rotor 40 and the stator 30 and can be a part that supports the smooth rotation of the internal parts.

A wheel assembly structure of a vehicle according to an embodiment of the present disclosure may further include a wheel hub 25 extending from a central portion of the wheel 20 toward a vehicle inner side, and a body engage bracket 7 connected to the stator housing 30, and extending toward the vehicle inner side.

The wheel hub 25 may be connected to a trailing arm 33 elongated toward the inner side of the vehicle and supporting the wheel 20. A shock absorber 62 configured to alleviate the shock transferred from the wheel 20 to the body 5 of the vehicle may be installed between an upper portion of this trailing arm 33 and a lower body 5 of the vehicle.

The damping device 70 may be provided between the inner circumference of the wheel 20 and the outer circumference of the rotor housing 40, and may be formed of a polymer material having elasticity.

The damping device 70 may be composed of an air spring, and may be formed by connecting a plurality of cross-sections having a hexagonal-shaped hollow.

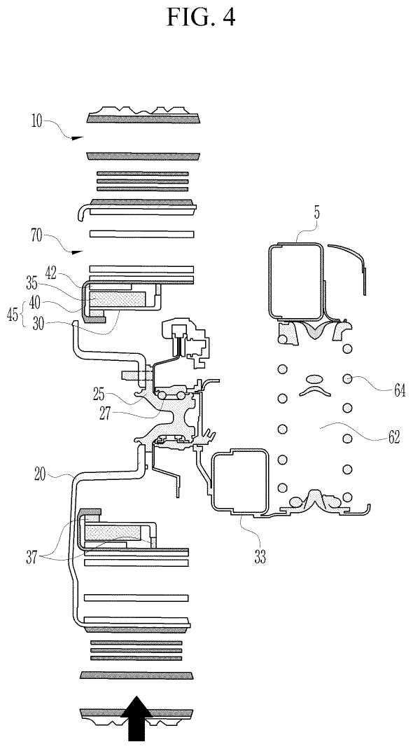

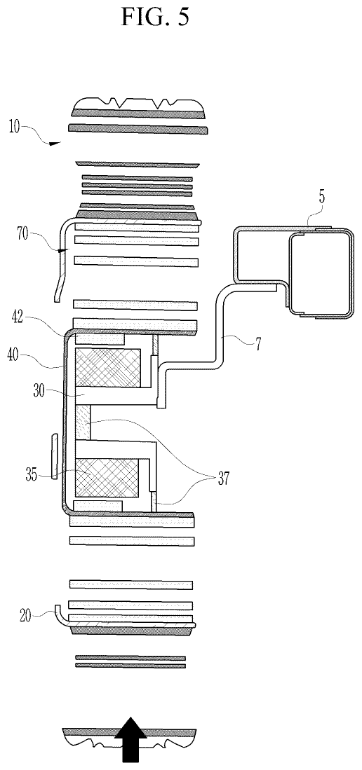

FIG. 4 is a cross-sectional view taken along line ‘A-A’ of FIG. 2. FIG. 5 is a cross-sectional view taken along line ‘B-B’ of FIG. 2.

Referring to FIG. 4 and FIG. 5, a wheel assembly structure of a vehicle according to an embodiment of the present disclosure may further include the wheel hub 25 extending toward the vehicle inner side from the central portion of the wheel 20, and the body engage bracket 7 connected to the stator housing 30, and extending toward the vehicle inner side.

The trailing arm 33 can be connected to the wheel hub 25 and elongated toward the interior of the vehicle to support the wheel 20. The wheel hub 25 and the trailing arm 33 may be rotatably connected by a wheel hub bearing 27.

The wheel hub 25 may protrude from the central portion of the wheel 20 toward the vehicle inner side, and the trailing arm 33 may be connected to this protruded portion. The body engage bracket 7 may be connected to the stator housing 30, and may extend toward the vehicle inner side, to be connected to the body 5 of the vehicle.

A permanent magnet 42 may be provided on an interior surface of the rotor housing 40 facing a rotation axis of the rotor housing 40, and a coil 35 may be provided at a location facing the permanent magnet 42, on an exterior surface of the stator housing 30. When electric power is applied to the coil 35, the electromagnetic force may be generated, and thereby causing the rotor housing 40 to rotate relative to the stator housing 30. A rotation of the rotor housing 40 may cause the wheel 20 to rotate.

A motor bearing 37 can be provided between an end portion of a central shaft of the stator housing 30 and the rotor housing 40, so that the rotor housing 40 relatively rotates with respect to the stator housing 30.

The shock absorber 62 can be configured to alleviate the shock transferred from the wheel 20 to the body 5 of the vehicle and may be installed between the upper portion of the trailing arm 33 and the body 5 of the vehicle. The shock absorber 62 may be supported by an upper surface of the trailing arm 33, and may be connected to a lower surface of the body 5. A spring 64, which can be configured to support the upper surface of the trailing arm 33 and the body 5 of the vehicle, can support the load of the vehicle, and alleviate the shock, and may be provided on a circumference of (outside of) the shock absorber 62.

The shock absorber 62 is an example of a suspension, and may be installed on the upper surface of the trailing arm 33 to absorb the shock from the road surface, thereby serving to improve the ride comfort and reduce the damage to the vehicle.

The shock absorber 62 may have an upper end supported by the body 5 of the vehicle by a bump stopper. The bump stopper may prevent the shock absorber 62 from being in direct contact and collided with the body 5 of the vehicle, and may be made of a polymer material having elasticity.

Although not shown in the drawings, a wheel assembly structure of a vehicle according to an embodiment may include a motor damping member interposed between the circumference of the central shaft of the stator housing 30 and the rotor housing 40 and configured to alleviate the shock between the stator housing 30 and the rotor housing 40. The motor damping member may be made of an elastic polymeric material. Due to the motor damping member, the wheel 20 and the in-wheel motor 45 may relatively move up and down, may protect the in-wheel motor 45 from the shock from below, and may reduce vibration.

A motor damping member may be provided on an outer side of the in-wheel motor 45 that is, an outer circumference of the stator housing 30.

A wheel assembly structure of a vehicle according to an embodiment of the present disclosure may be applied to, for example, a purpose-built vehicle (PBV). The wheel assembly structure may be modularized and applied to an underbody (e.g., skateboard) of a vehicle body of the PBV.

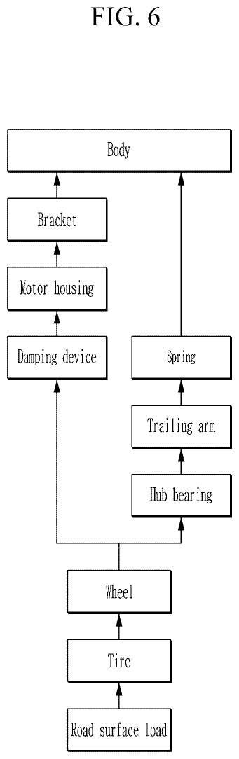

FIG. 6 is a drawing schematically showing a path along which a shock of the vehicle lower body can be transferred, in a wheel assembly structure of a vehicle according to an embodiment of the present disclosure.

Referring to FIGS. 4-6, the shock (load) transferred from the road surface to the vehicle may be transferred to the tire 10 and the wheel 20, and may be transferred to the damping device 70 provided between the inner circumference of the wheel 20 and the outer circumference of the rotor housing 40. The load transferred to the damping device 70 may be transferred to the rotor housing 40, and may be transferred to the body 5 via the body engage bracket 7 of the vehicle connected to the stator housing 30.

Referring to FIG. 4 and FIG. 6, the shock (load) transferred from the road surface to the vehicle may be transferred to the tire 10 and the wheel 20, and may be transferred to the wheel hub 25 extending from a central portion toward the vehicle inner side. The wheel hub 25 and the trailing arm 33 may be rotatably connected by the wheel hub bearing 27, and the load may be transferred from the wheel hub 25 to the trailing arm 33 via the wheel hub bearing 27. The load may be transferred to the spring 64 provided on the circumference of the shock absorber 62 supported by the upper portion of the trailing arm 33, and may be transferred to the body 5 of the vehicle in contact with and supported by an upper portion of the spring 64.

That is, between the outer circumference of the rotor housing 40 and the inner circumference of the wheel 20, the shock transferred from the wheel 20 to the rotor housing 40 may be transferred to the body 5 through the shock absorber 62. A part of a shock transferred to the body 5 may be transferred to the damping device 70. A part of a shock transferred to the damping device 70 may be transferred to the motor composed of the rotor housing and the stator housing.

One load path can be from the tire 10 to the wheel 20, from the wheel 20 to the damping device 70, from the damping device 70 to the rotor housing 40, from the rotor housing 40 to the motor bearing 37, from the motor bearing 37 to the stator housing 30, from the stator housing 30 to the body engage bracket 7, from the body engage bracket 7 to the body 5. And another load path can be from the tire 10 to the wheel 20, from the wheel 20 to the wheel hub 25, from the wheel hub 25 to the wheel hub bearing 27, from the wheel hub bearing 27 to the trailing arm 33, from the trailing arm 33 to the shock absorber 62 and spring 64, from the shock absorber 62 and spring 64 to the body 5. Thus, a first load path from the tire 10 to the body 5 via the in-wheel motor 45 (including rotor housing 40, motor bearing 37, and stator housing 30), can be different than a second load path from the tire 10 to the body 5 via the wheel hub 25 and a suspension system (including trailing arm 33, shock absorber 62, and spring 64).

As such, the load transferred from the road surface to the vehicle may have a shock alleviation structure of dual paths, in which the load can be absorbed by the damping device provided between the inner circumference of the wheel and the outer circumference of the rotor housing and transferred to the vehicle body, and in addition, absorbed by the spring provided on the shock absorber circumference via the wheel hub and the trailing arm, to be transferred to the vehicle body so that an excessive load may be prevented from being concentrated on the shock absorber, and durability may be improved.

The configuration of the damping device 70 of an air spring type configured to absorb the load transferred to the in-wheel motor 45, and the shock absorber configured to absorb the load transferred through the bearing of the wheel hub may be separately install on each body, so that a spatial degree of freedom may be improved in the design.

By providing the wheel assembly structure including a motor damping member (e.g., damping device 70) between the in-wheel motor including the stator and the rotor, it can be possible to alleviate the shock from the lower portion of the vehicle being transmitted to the in-wheel motor and strengthen the durability of the high-voltage cable connected to the in-wheel motor.

According to an embodiment of the present disclosure, by applying to a skateboard platform applied to mobility vehicles, it can be possible to greatly contribute to the marketability of the mobility vehicle.

While the present disclosure has been described in connection with what is presently considered to be practical example embodiments, it can be understood that the present disclosure is not necessarily limited to the disclosed example embodiments. On the contrary, the present disclosure can cover various modifications and equivalent arrangements included within the spirit and scopes of the appended claims.

What is claimed is:

1. A vehicle wheel assembly structure, comprising:
a tire;
a wheel on which the tire is mounted;
a rotor housing connected to the wheel and configured to rotate with the wheel;
a stator housing configured to be fixed to a vehicle body, and configured to rotate the rotor housing based on an application of an electrical current at the stator housing; and
a damping device coupled between an inner circumference of the wheel and an outer circumference of the rotor housing, wherein the damping device is configured to alleviate a first shock transferred from the wheel to the rotor housing.

2. The structure of claim 1, further comprising a wheel hub coupled to a central portion of the wheel, such that the wheel hub extends toward a vehicle inner side from the central portion of the wheel.

3. The structure of claim 1, further comprising a body engage bracket connected to the stator housing, such that the body engage bracket extends toward a vehicle inner side from the stator housing, and wherein the body engage bracket is configured to connect the stator housing to the vehicle body.

4. The structure of claim 2, further comprising a trailing arm coupled to the wheel hub, such that the trailing arm is elongated toward the vehicle inner side and configured to support the wheel.

5. The structure of claim 4, further comprising a shock absorber connected to an upper portion the trailing arm, wherein the shock absorber is configured to alleviate a second shock transferred from the wheel to the vehicle body.

6. The structure of claim 5, further comprising a spring around a circumference of the shock absorber, wherein the spring is configured to be disposed between an upper surface of the trailing arm and the vehicle body, and wherein the spring is configured to support a load of the vehicle body and alleviate the second shock.

7. The structure of claim 6, wherein the structure is configured such that a total shock applied to the tire is divided between the first shock alleviated by the damping device and the second shock alleviated by the spring and the shock absorber.

8. The structure of claim 7, comprising an in-wheel electric motor including the rotor housing and the stator housing, wherein the damping device is configured to alleviate the first shock between the wheel and the in-wheel electric motor.

9. The structure of claim 1, further comprising:
a permanent magnet at a radially interior surface of the rotor housing facing a rotation axis of the rotor housing; and
a coil at a radially exterior surface of the stator housing facing the permanent magnet, providing an in-wheel electric motor configuration such that the rotor housing is configured to rotate by electromagnetic force generated by applying electric power to the coil.

10. The structure of claim 2, further comprising:
a trailing arm configured to be pivotably coupled to the vehicle body; and
a wheel hub bearing, wherein the wheel hub and the trailing arm are rotatably connected by the wheel hub bearing.

11. The structure of claim 1, further comprising a motor bearing between an end portion of a central shaft of the stator housing and the rotor housing, so that the rotor housing can relatively rotate with respect to the stator housing.

12. The structure of claim 1, wherein the damping device includes an air spring.

13. The structure of claim 12, wherein the damping device includes a plurality of cross-section portions having a hexagonal-shaped hollow.

14. A vehicle wheel assembly structure comprising:
a wheel hub;
a wheel fixed to the wheel hub;
a wheel hub bearing;
a suspension arm rotatably coupled to the wheel hub via the wheel hub bearing, wherein the suspension arm is configured to be rotatably coupled to a vehicle body such that the suspension arm extends between the vehicle body and the wheel hub;
a suspension system comprising:
a shock absorber, and
a spring, wherein the suspension system is configured to be disposed between the vehicle body and the suspension arm;
an in-wheel electric motor comprising:
a motor bearing,
a rotor housing, and
a stator housing rotatably coupled to the rotor housing via the motor bearing, wherein the in-wheel electric motor is disposed radially outside of the wheel hub and at least partially in the wheel;
a damping device fixed to the wheel radially outside of the in-wheel electric motor and fixed to the rotor housing of the in-wheel electric motor, wherein the damping device is configured such that the in-wheel electric motor can drive rotation of the wheel via the damping device; and
a motor bracket fixed to the stator housing of the in-wheel electric motor and configured to be fixed to the vehicle body such that the stator housing of the in-wheel electric motor is fixed relative to the vehicle body.

15. The structure of claim 14, wherein the structure is configured such that a total load applied to the wheel is transferred to the vehicle body by a first load path and a second load path;
wherein the first load path is from the wheel to the damping device, from the damping device to the rotor housing, from the rotor housing to the motor bearing, from the motor bearing to the stator housing, from the stator housing to the motor bracket, and from the motor bracket to the vehicle body; and
wherein the second load path is from the wheel to the wheel hub, from the wheel hub to the wheel hub bearing, from the wheel hub bearing to the suspension arm, from the suspension arm to the suspension system, from the suspension system to the vehicle body.

16. The structure of claim 14, wherein the damping device comprises a flexible material having a plurality of ribs separated by a plurality of hexagon-shaped holes extending in an axial direction.

17. The structure of claim 14, wherein the in-wheel electric motor further comprises:
a permanent magnet at a radially interior surface of the rotor housing facing a rotation axis of the rotor housing; and
a coil at a radially exterior surface of the stator housing facing the permanent magnet, providing an in-wheel electric motor configuration such that the rotor housing is configured to rotate by electromagnetic force generated by applying electric power to the coil.

18. A vehicle comprising:
a body;
a wheel hub;
a wheel fixed to the wheel hub;
a wheel hub bearing;
a suspension arm rotatably coupled to the wheel hub via the wheel hub bearing, wherein the suspension arm is rotatably coupled to the body, such that the suspension arm extends between the body and the wheel hub;
a suspension system comprising:
a shock absorber, and
a spring, wherein the suspension system is disposed between the body and the suspension arm;
an in-wheel electric motor comprising:
a motor bearing,
a rotor housing, and
a stator housing rotatably coupled to the rotor housing via the motor bearing, wherein the in-wheel electric motor is disposed radially outside of the wheel hub and at least partially in the wheel;
a damping device fixed to the wheel radially outside of the in-wheel electric motor and fixed to the rotor housing of the in-wheel electric motor, wherein the damping device is configured such that the in-wheel electric motor can drive rotation of the wheel via the damping device; and
a motor bracket fixed to the stator housing of the in-wheel electric motor and fixed to the body, such that the stator housing of the in-wheel electric motor is fixed relative to the body.

19. The vehicle of claim 18, wherein the vehicle is configured such that a total load applied to the wheel is transferred to the body by a first load path and a second load path;
wherein the first load path is from the wheel to the damping device, from the damping device to the rotor housing, from the rotor housing to the motor bearing, from the motor bearing to the stator housing, from the stator housing to the motor bracket, and from the motor bracket to the body; and
wherein the second load path is from the wheel to the wheel hub, from the wheel hub to the wheel hub bearing, from the wheel hub bearing to the suspension arm, from the suspension arm to the suspension system, from the suspension system to the body.

20. The vehicle of claim 19, wherein the damping device comprises a flexible material having a plurality of ribs separated by a plurality of hexagon-shaped holes extending in an axial direction.
